(19) United States
(12) Patent Application Publication
(10) Pub. No.: US 2003/0068547 A1
(43) Pub. Date: Apr. 10, 2003

(54) Modularized battery case

(76) Inventor: Chieh-Feng Wu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/972,976

(22) Filed: Oct. 10, 2001

(51) Int. Cl. H01M 2/10

(52) U.S. Cl. 429/99; 429/100

(57) ABSTRACT

A modularized battery case comprises a stage with a battery tank for accommodating battery. The stage has two opposite sidewalls and each sidewall has a clamping member thereon. The clamping member has a through hole through which corresponding fixing members passes to retain the stage. The stage further has two opposite lateral sides and each lateral side has a wing portion with a through hole formed by replacing mold. The through hole on the wing portion is corresponding to a mounting position of the stage. The modularized battery case of the present invention can be applied to various product and models. The developing cycle of the modularized battery case of the present invention is reduced to save cost and provides more competence.

### FIELD OF THE INVENTION

The present invention relates to a modularized battery case, especially to a modularized battery case suitable for portable electronic device such as wireless keyboard.

### BACKGROUND OF THE INVENTION

The wireless computer peripherals such as wireless keyboard provide more convenience for operation and become more and more popular. The wireless computer peripherals generally have battery tank for accommodating battery therein for powering the wireless computer peripheral.

In prior art wireless computer peripheral; the battery tank thereof is integrally formed in the casing of the wireless computer peripheral by injection molding. As a result, the tank and the electrode plate of the battery are generally tailored with specific wireless computer peripheral. This is cumbersome and increases cost.

As can be seen from above description, a modularized battery tank can be universally used for various kinds of wireless computer peripherals. Moreover, the manufacture cost and developing time of the wireless computer peripherals can be reduced.

### SUMMARY OF THE INVENTION

It is the object of the present invention to provide a modularized battery case, which can be arranged on an upper shell or a lower shell of a housing. The modularized battery case of the present invention can be applied to various product and models. The developing cycle of the modularized battery case of the present invention is reduced to save cost and provides more competence.

To achieve above object, the present invention provides a modularized battery case having a stage with a battery tank for accommodating at least one battery. The stage having two opposite sidewalls each installed a clamping member and two opposite lateral sides each installed a wing portion thereon, the clamping member and the wing portion each formed at least one through hole through which corresponding fixing members pass; at least one through hole on the wing portion is corresponding to a mounting position of the stage.

The various objects and advantages of the present invention will be more readily understood from the following detailed description when read in conjunction with the appended drawing, in which:

### BRIEF DESCRIPTION OF DRAWINGS

FIG. 1 shows an exploded view of the present invention;

FIG. 2 shows a perspective view of the present invention;

FIG. 3 shows another perspective view of the present invention;

FIG. 4 shows a sectional view with the inventive battery case arranged on a lower shell; and

FIG. 5 shows a sectional view with the inventive battery case arranged on an upper shell.

### DETAILED DESCRIPTION OF THE INVENTION

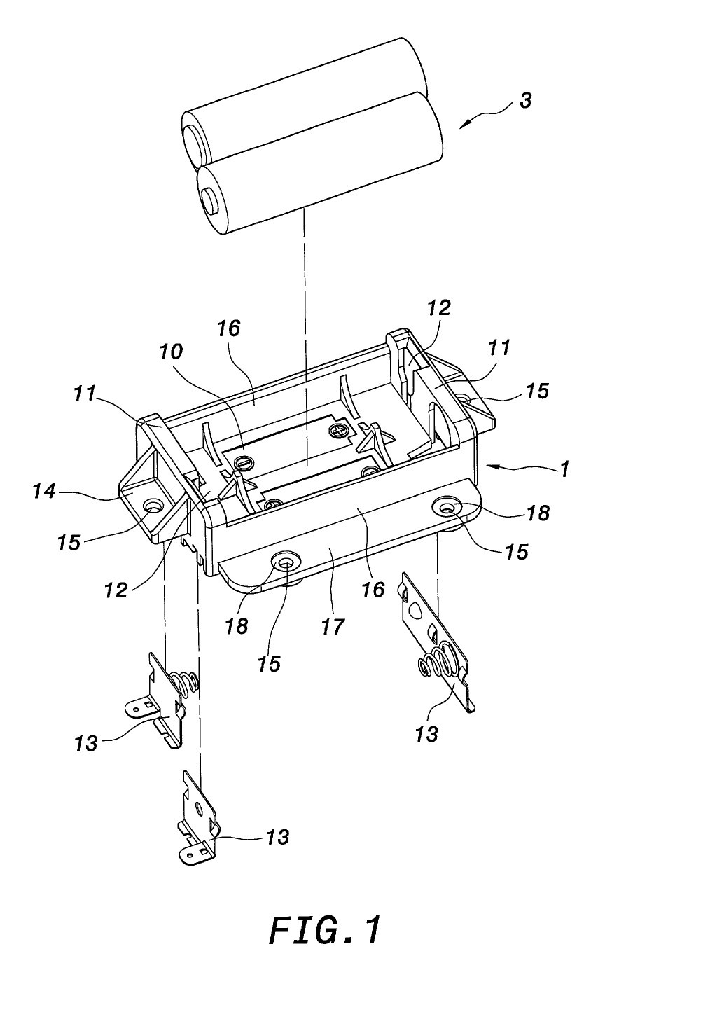

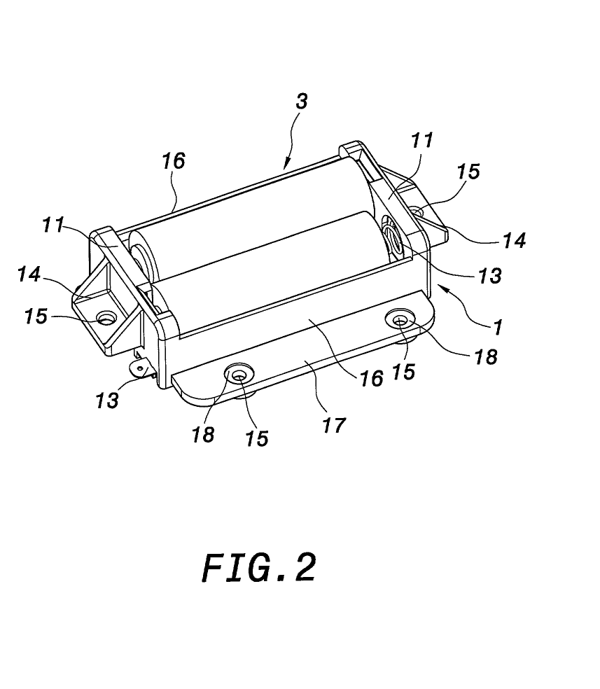

FIGS. 1, 2 and 3 show the exploded view, the perspective view and the perspective view from another viewing angle of the present invention, respectively. The modularized battery case according to the present invention comprises a stage 1 containing a battery tank 10 for accommodating a set of battery 3. The battery tank 10 has a size fit with that of the battery 3. The battery tank 10 has two opposite sidewalls 11, each sidewall 11 has an embedding groove 12 for accommodating an electrode plate 13, thus forming closed loop for the battery.

The stage 1 has two clamping members 14 on outer surfaces of the two opposite sidewalls 11, respectively. Each clamping member 14 has a through hole 15 thereon and a fixing member 24 passes through the through hole 15 to retain the stage 1, as shown in FIGS. 5 and 6. The fixing member 24 can be screw, tenon, pin or rivet.

The stage 1 has two other opposite sidewalls 16 adjacent to the sidewalls 11, and two flat wing portions 17 are formed on the opposite sidewalls 16, respectively. Each wing portion 17 also has a through hole 15 thereon and a fixing member 24 passes through the through hole 15. The through hole 15 on the wing portion 17 can be formed by replacing mold; and the positions and the number of the through hole 15 on the wing portion 17 can be modified in view of practical situation.

Moreover, the wing portion 17 has an indent 18 at one side of the through hole 15. The indent 18 facilitates the alignment of the stage 1 during assembling.

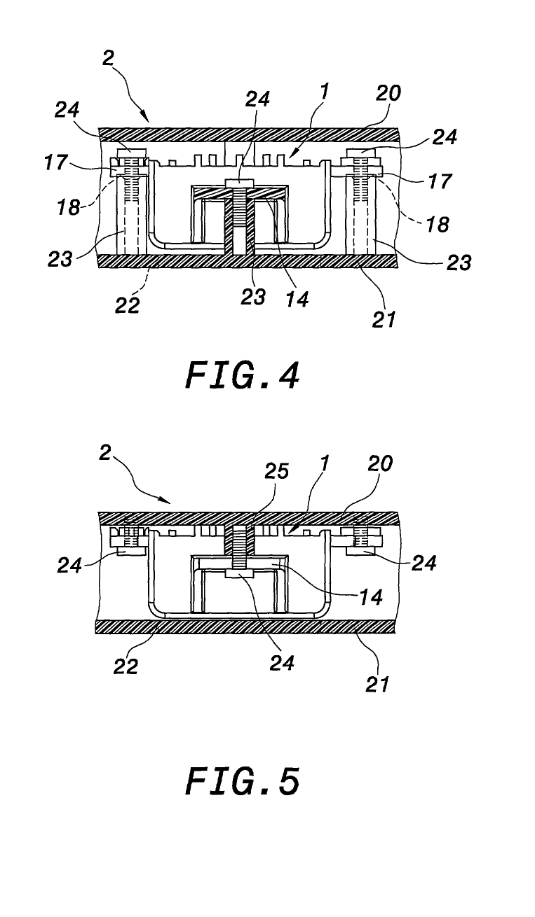

As shown in FIG. 4, the modularized battery case of the present invention can be arranged on a lower shell 21 of a housing 2 of an electronic apparatus, wherein the electronic apparatus has a housing 2 composed of an upper shell 20 and a lower shell 21. Moreover, a battery cover 22 is arranged on the lower shell 21 of the housing 2. The lower shell 21 of the housing 2 has a plurality of positioning posts 23 thereon. As shown in this figure, the battery tank 10 is placed atop the battery cover 22 and the positioning posts 23 are engaged into the indents 18 of the wing portions 17 of the stage 1, whereby the stage 1 is positioned. Afterward, the clamping members 14 and the wing portions 17 are locked by the fixing members 24 and the upper shell 20 is placed atop the overall structure.

As shown in FIG. 5, the modularized battery case of the present invention can be arranged on an upper shell 20 of a housing 2 of an electronic apparatus. The battery tank 10 is located at a location corresponding to the battery cover 22 and the clamping members 14 are locked to a plurality of positioning posts 25 arranged on the upper shell 20. The wing portions 17 are attached to an inner surface of the upper shell 20 and are locked by the fixing members 24. Afterward, the lower shell 21 of the housing 2 is assembled to the resulting structure.

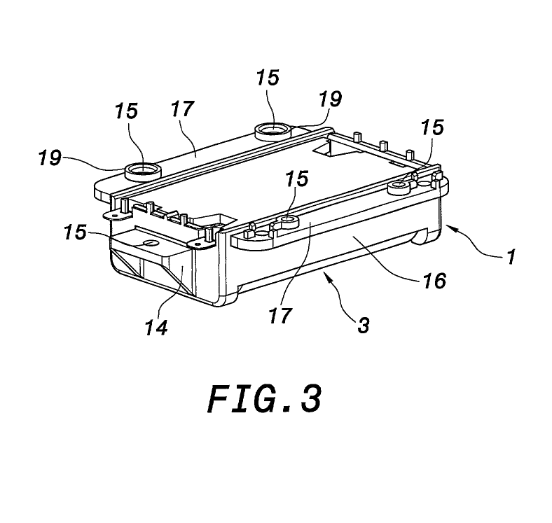

Moreover, as shown in FIG. 3, the wing portion 17 has a projecting ring 19 at another side of the through hole 15. The projecting ring 19 facilitates the screw 24 being screwed into the through hole 15 and protects a head of the screw 24 from damage.

The modularized battery case of the present invention has following advantages:

1. The design effort for the battery case and associated electrode plate can be saved for new product.

2. The repertory amount of the battery case is reduced due to modularized design thereof.

3. The modularized battery case of the present invention can be applied to various product and models.

4. The developing cycle of the modularized battery case of the present invention is reduced to save cost and provides more competence.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A modularized battery case comprising a stage with a battery tank for accommodating at least one battery, the stage having two opposite sidewalls each installed a clamping member and two opposite lateral sides each installed a wing portion thereon, the clamping member and the wing portion each formed at least one through hole through which corresponding fixing members pass; at least one through hole on the wing portion is corresponding to a mounting position of the stage.

2. The modularized battery case as in claim 1, wherein the tank has two electrode plates arranged on the opposite sidewalls.

3. The modularized battery case as in claim 1, wherein the wing portion has an indent on one side of the through hole thereof.

4. The modularized battery case as in claim 1, wherein the wing portion has a projecting ring on another side of the through hole thereof.
